(19) United States
(12) Patent Application Publication
(10) Pub. No.: US 2026/0354629 A1
(43) Pub. Date: Nov. 12, 2026

(54) TOWEL HEATING BUCKET WITH FLAME EFFECT

(71) Applicant: DONGGUAN GOLDENHOT PLASTIC&HARDWARE PRODUCTS CO.,LTD., DONGGUAN (CN)

(72) Inventors: XIUHUA ZHAO, DONGGUAN (CN); WEIQI CHAO, DONGGUAN (CN)

(21) Appl. No.: 19/212,729

(22) Filed: May 20, 2025

(30) Foreign Application Priority Data
May 6, 2025 (CN) 202520874999.6

(51) Int. Cl. A47K 10/06; F21S 10/04; F24C 7/00; H05B 3/06

(52) U.S. Cl. CPC A47K 10/06; F21S 10/046; F24C 7/004; H05B 3/06; H05B 2203/003

(57) ABSTRACT

This utility patent discloses a towel heating bucket with a flame effect, pertaining to the technical field of towel heating buckets and including a bucket housing and an inner heating bucket, where a flame simulation mechanism is disposed on a front side of the inner heating bucket. A key technical point of this utility patent is as follows: During working, the flame simulation mechanism can simulate a burning charcoal fire, which can not only vividly express a heating state, but also provide users with psychological warmth, thereby providing an emotional value.

### TECHNICAL FIELD

This utility patent relates to the technical field of towel heating buckets, and specifically, to a towel heating bucket with a flame effect.

A towel heating bucket is a practical household appliance, mainly configured to warm and dry items such as towels and bathrobes, to provide more comfortable and convenient use experience for a user. Towel heating buckets are widely used in places such as homes, hotels, beauty salons, and barber shops. In home environments, the towel heating buckets can provide users with warm towels to increase comfort in bathing; and in the hotels and beauty salons, the towel heating buckets can improve overall experience of customers, exhibiting high quality of service.

Existing towel heating buckets in the art have monotonous patterns, and cannot provide real-time, intuitive feedback about their operational status. That is, current internal heating efficiency and heating states of the buckets cannot be vividly presented to the users, and usually the foregoing information can be reflected only through a digital display screen, which is less vivid. In addition, the digital display screen gives users a relatively cold visual impression other than psychological warmth in winter and therefore, has difficulty in offering users additional emotional values. Therefore, in view of the foregoing problems, a towel heating bucket with a flame effect is proposed.

To resolve the technical problem, this utility patent provides a towel heating bucket with a flame effect, where a flame simulation mechanism and a regulator are disposed on a front side of the towel heating bucket, and a flame lamp board, a charcoal fire simulation board, and a reflective mechanism are disposed inside the flame simulation mechanism. When the heating bucket is working, the flame lamp board illuminates the charcoal fire simulation board, so that the charcoal fire simulation board can simulate a burning charcoal fire. In addition, the reflective mechanism can periodically reflect light, so that the charcoal fire presents a dancing state, which is more vivid. When the working state of the heating bucket is adjusted via the regulator, the flame simulation mechanism can also be synchronously adjusted, to differentiate display brightness and effects of the simulated charcoal fires. For example, high temperature is used to simulate a more vigorous charcoal fire, and low temperature or a heat preservation stage is used to simulate a dim charcoal fire, so that the heating state can be vividly expressed and the user can be provided with psychological warmth in winter, thereby providing an emotional value. Therefore, the technical problem in the prior art is resolved, that is, internal working states of the towel heating buckets are difficult to feed back in real time or vividly, and usually the foregoing information can be reflected only through a digital display screen, which cannot provide users with psychological warmth in winter or additional emotional values.

Technical solutions adopted to resolve the technical problems in the embodiments of this application are as follows:

A towel heating bucket with a flame effect includes: a bucket housing in which an inner heating bucket is fixedly disposed, where a top frame is fixedly disposed at a top end of the inner heating bucket and rotatably connected to a flip cover; a flame simulation mechanism, installed on a front surface of the inner heating bucket; and a regulator, instaled at an upper part of the front surface of the inner heating bucket, where the flame simulation mechanism includes a light shielding box in which a reflective mechanism is disposed, a flame lamp board is installed on a bottom side of the light shielding box, a charcoal fire simulation board is installed on a front side of the light shielding box, and a transparent cover plate is disposed on a front cover of the charcoal fire simulation board. Based on the foregoing technical solution, when the heating bucket is working, the flame lamp board illuminates the charcoal fire simulation board, so that the charcoal fire simulation board can simulate a burning charcoal fire. In addition, the reflective mechanism can periodically reflect light, so that the charcoal fire presents a dancing state, which is more vivid. When the working state of the heating bucket is adjusted via the regulator, the flame simulation mechanism can also be synchronously adjusted, to differentiate display brightness and effects of the simulated charcoal fires. For example, high temperature is used to simulate a more vigorous charcoal fire, and low temperature or a heat preservation stage is used to simulate a dim charcoal fire, so that the heating state can be vividly expressed and the user can be provided with psychological warmth in winter, thereby providing an emotional value.

In a possible implementation, the flame lamp board includes a circuit board on which two rows of flame lamp beads are installed, where flame lamp beads in a rear row are higher than flame lamp beads in a front row. With such arrangement, the charcoal fire simulated by irradiation of the flame lamp bead can be more stereoscopic and vivid.

In a possible implementation, the charcoal fire simulation board includes a transparent substrate, provided with transparent simulation blocks at its front bottom, and the transparent simulation blocks are in a shape of a stacked charcoal fire. The transparent substrate can allow light to be incident on the transparent simulation blocks, and the transparent simulation blocks present an image of the charcoal fire after irradiating light is reflected and refracted, to obtain a simulation effect.

In a possible implementation, the reflective mechanism includes a drive motor that is installed on a side surface of the light shielding box and whose output shaft is fixedly connected to a drive shaft, and multiple rolling reflective sheets that are spirally distributed are fixedly connected to the drive shaft. During working, the drive motor can drive the drive shaft to drive the rolling reflective sheets to rotate, to periodically reflect light, so that the reflected light has a characteristic of movement and the simulated flame can have a dancing effect.

In a possible implementation, the inner heating bucket includes an outer bucket layer and an inner bucket layer, and a heating wire is disposed therebetween and wound around the inner bucket layer into a corrugated shape. When being electrified, the heating wire can release heat, to exert a heating effect on the towel in the inner bucket layer, and the foregoing structure can avoid direct contact between the heating wire and the towel, thereby avoiding scalding the towel at high temperature.

In a possible implementation, a power cord is disposed at a bottom of the bucket housing, a storage plate is fixedly disposed at a center of the bottom of the bucket housing, and a wire accommodation groove configured to accommodate the power cord is disposed in the storage plate. With the foregoing structure, the power cord can be accommodated through the wire accommodation groove when the power cord is not in use, thereby avoiding scattering the power cord.

In a possible implementation, the storage plate is provided with a plug fixing groove and a fixing clamping groove, both of which communicate with the wire accommodation groove, where the plug fixing groove is located in the wire accommodation groove and configured to fix a plug part of the power cord, and the fixing clamping groove is on an outer side of the wire accommodation groove. Based on the foregoing technical solution, when the heating bucket is not in use, the plug of the power cord is fixed through the plug fixing groove, and when the heating bucket is used, the fixing clamping groove can position and fix an end part of the power cord that is pulled out, to facilitate use.

In a possible implementation, the regulator is electrically connected to the inner heating bucket and the flame simulation mechanism to regulate working states thereof. Through this technical solution, linkage between adjustment of the working state of the inner heating bucket and a change in the flame effect of the flame simulation mechanism can be implemented.

In conclusion, this utility patent has the following beneficial technical effects:

The flame simulation mechanism and the regulator are disposed on a front side of the towel heating bucket, and the flame lamp board, the charcoal fire simulation board, and the reflective mechanism are disposed inside the flame simulation mechanism. When the heating bucket is working, the flame lamp board illuminates the charcoal fire simulation board, so that the charcoal fire simulation board can simulate a burning charcoal fire. In addition, the reflective mechanism can periodically reflect light, so that the charcoal fire presents a dancing state, which is more vivid. When the working state of the heating bucket is adjusted via the regulator, the flame simulation mechanism can also be synchronously adjusted, to differentiate display brightness and effects of the simulated charcoal fires. For example, high temperature is used to simulate a more vigorous charcoal fire, and low temperature or a heat preservation stage is used to simulate a dim charcoal fire, so that the heating state can be vividly expressed and the user can be provided with psychological warmth in winter, thereby providing an emotional value.

### BRIEF DESCRIPTION OF THE DRAWINGS

The drawings are used to facilitate further understanding of this utility patent, form a part of the specification, and are used with embodiments of this utility patent jointly to explain this utility patent, but do not constitute a limitation on this utility patent. In the drawings:

FIG. 1 is a schematic diagram of an overall structure according to this utility patent;

FIG. 2 is a schematic diagram of structural composition according to this utility patent;

FIG. 3 is a schematic structural diagram of a flame simulation mechanism according to this utility patent;

FIG. 4 is a schematic diagram of a partial structure of a part of a flame simulation mechanism according to this utility patent;

FIG. 5 is a schematic structural diagram of an inner heating bucket according to this utility patent; and

FIG. 6 is a schematic structural diagram of a bottom of a heating bucket according to this utility patent.

Reference signs in the drawings: 1. bucket housing; 2. inner heating bucket; 21. outer bucket layer; 22. inner bucket layer; 23. heating wire; 3. flame simulation mechanism; 31. light shielding box; 32. flame lamp board; 321. circuit board; 322. flame lamp bead; 33. reflective mechanism; 331. drive motor; 332. drive shaft; 333. rolling reflective sheet; 34. charcoal fire simulation board; 341. transparent substrate; 342. transparent simulation block; 35. transparent cover plate; 4. top frame; 5. flip cover; 6. regulator; 7. storage plate; 71. wire accommodation groove; 72. plug fixing groove; 73. fixing clamping groove; and 8. power cord.

### DETAILED DESCRIPTION OF EMBODIMENT

The technical solutions in the embodiments of this application are intended to resolve the problems in the foregoing background section, and a general idea is as follows:

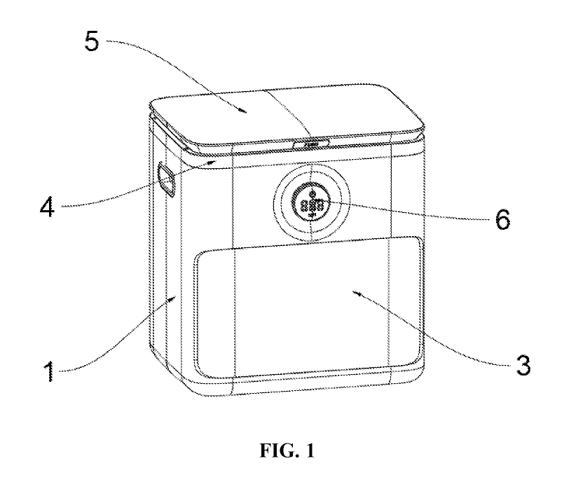

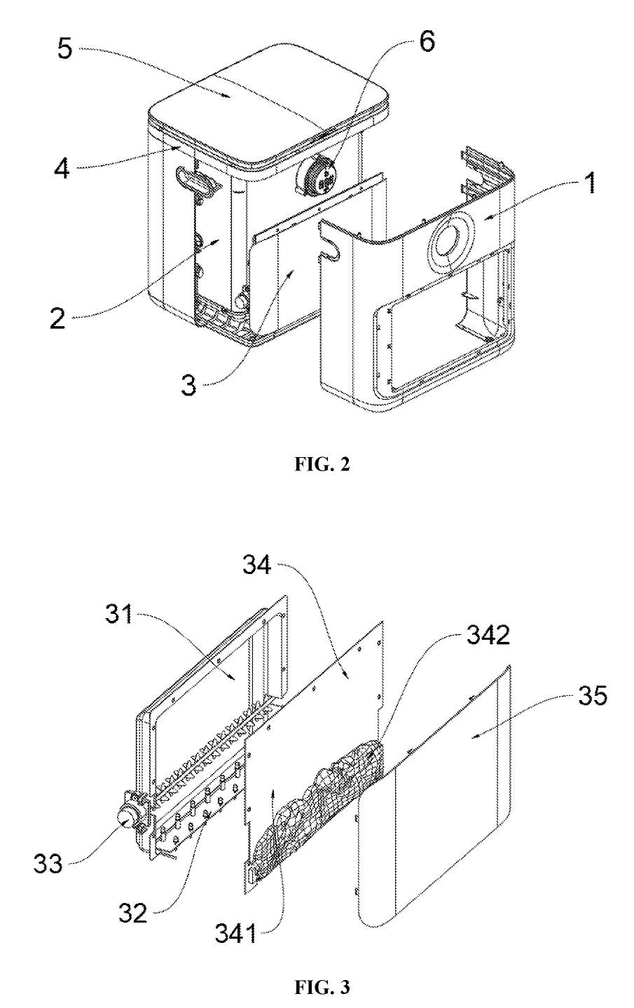

As shown in FIG. 1 to FIG. 3, this embodiment provides a towel heating bucket with a flame effect, including: a bucket housing 1 in which an inner heating bucket 2 is fixedly disposed, where a top frame 4 is fixedly disposed at a top end of the inner heating bucket 2 and rotatably connected to a flip cover 5; a flame simulation mechanism 3, installed on a front surface of the inner heating bucket 2; and a regulator 6, instaled at an upper part of the front surface of the inner heating bucket 2, where the flame simulation mechanism 3 includes a light shielding box 31 in which a reflective mechanism 33 is disposed, a flame lamp board 32 is installed on a bottom side of the light shielding box 31, a charcoal fire simulation board 34 is installed on a front side of the light shielding box 31, and a transparent cover plate 35 is disposed on a front cover of the charcoal fire simulation board 34. Based on the foregoing technical solution, when the heating bucket is working, the flame lamp board 32 illuminates the charcoal fire simulation board 34, so that the charcoal fire simulation board 34 can simulate a burning charcoal fire. In addition, the reflective mechanism 33 can periodically reflect light, so that the charcoal fire presents a dancing state, which is more vivid. When the working state of the heating bucket is adjusted via the regulator 6, the flame simulation mechanism 3 can also be synchronously adjusted, to differentiate display brightness and effects of the simulated charcoal fires. For example, high temperature is used to simulate a more vigorous charcoal fire, and low temperature or a heat preservation stage is used to simulate a dim charcoal fire, so that the heating state can be vividly expressed and the user can be provided with psychological warmth in winter, thereby providing an emotional value.

The regulator 6 is electrically connected to the inner heating bucket 2 and the flame simulation mechanism 3 to regulate working states thereof. Through this technical solution, linkage between adjustment of the working state of the inner heating bucket 2 and a change in the flame effect of the flame simulation mechanism 3 can be implemented.

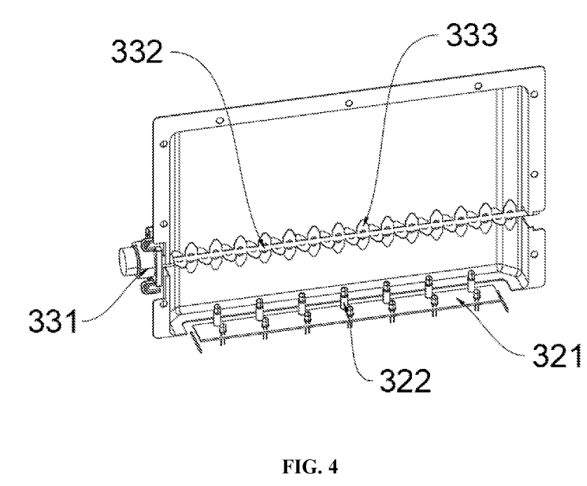

As shown in FIG. 3 and FIG. 4, the flame lamp board 32 includes a circuit board 321 on which two rows of flame lamp beads 322 are installed, where flame lamp beads 322 in a rear row are higher than flame lamp beads 322 in a front row. With such arrangement, the charcoal fire simulated by irradiation of the flame lamp bead 322 can be more stereoscopic and vivid. The charcoal fire simulation board 34 includes a transparent substrate 341, provided with transparent simulation blocks 342 at its front bottom, and the transparent simulation blocks 342 are in a shape of a stacked charcoal fire. The transparent substrate 341 can allow light to be incident on the transparent simulation blocks 342, and the transparent simulation blocks 342 present an image of the charcoal fire after irradiating light is reflected and refracted, to obtain a simulation effect.

As shown in FIG. 4, the reflective mechanism 33 includes a drive motor 331 that is installed on a side surface of the light shielding box 31 and whose output shaft is fixedly connected to a drive shaft 332, and multiple rolling reflective sheets 333 that are spirally distributed are fixedly connected to the drive shaft 332. During working, the drive motor 331 can drive the drive shaft 332 to drive the rolling reflective sheets 333 to rotate, to periodically reflect light, so that the reflected light has a characteristic of movement and the simulated flame can have a dancing effect.

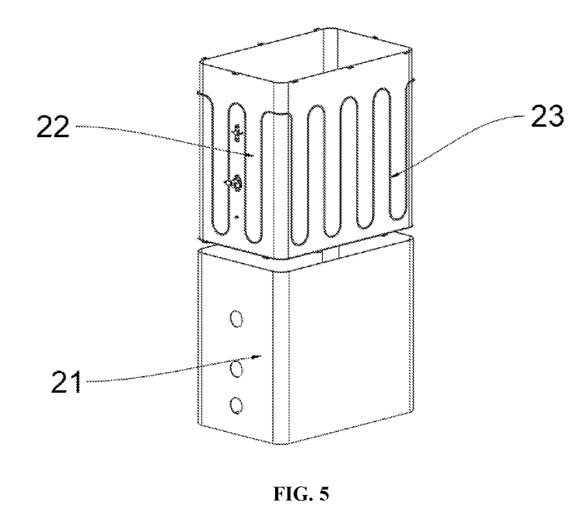

As shown in FIG. 5, the inner heating bucket 2 includes an outer bucket layer 21 and an inner bucket layer 22, and a heating wire 23 is disposed therebetween and wound around the inner bucket layer 22 into a corrugated shape. When being electrified, the heating wire 23 can release heat, to exert a heating effect on the towel in the inner bucket layer 22, and the foregoing structure can avoid direct contact between the heating wire 23 and the towel, thereby avoiding scalding the towel at high temperature.

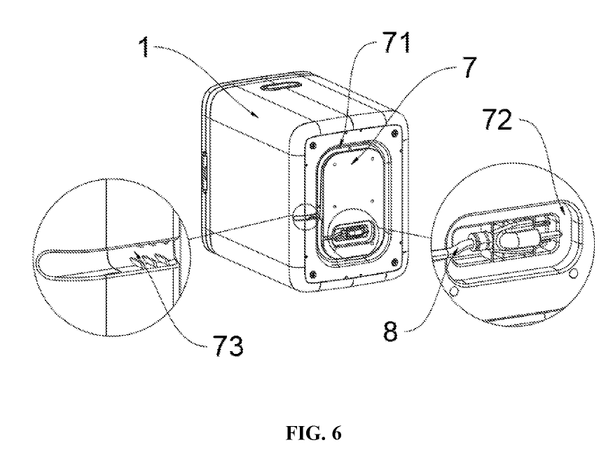

As shown in FIG. 6, a power cord 8 is disposed at a bottom of the bucket housing 1, a storage plate 7 is fixedly disposed at a center of the bottom of the bucket housing 1, and a wire accommodation groove 71 configured to accommodate the power cord 8 is disposed in the storage plate 7. With the foregoing structure, the power cord 8 can be accommodated through the wire accommodation groove 71 when the power cord 8 is not in use, thereby avoiding scattering the power cord 8. In addition, the storage plate 7 is provided with a plug fixing groove 72 and a fixing clamping groove 73, both of which communicate with the wire accommodation groove 71, where the plug fixing groove 72 is located in the wire accommodation groove 71 and configured to fix a plug part of the power cord 8, and the fixing clamping groove 73 is on an outer side of the wire accommodation groove 71. Based on the foregoing technical solution, when the heating bucket is not in use, the plug of the power cord 8 is fixed through the plug fixing groove 72, and when the heating bucket is used, the fixing clamping groove 73 can position and fix an end part of the power cord 8 that is pulled out, to facilitate use.

Use principle and use process of this utility patent:

The flame simulation mechanism 3 and the regulator 6 are disposed on a front side of the towel heating bucket, and the flame lamp board 32, the charcoal fire simulation board 34, and the reflective mechanism 33 are disposed inside the flame simulation mechanism 3. When the heating bucket is working, the flame lamp board 32 illuminates the charcoal fire simulation board 34, so that the charcoal fire simulation board 34 can simulate a burning charcoal fire. In addition, the reflective mechanism 33 can periodically reflect light, so that the charcoal fire presents a dancing state, which is more vivid. When the working state of the heating bucket is adjusted via the regulator 6, the flame simulation mechanism 3 can also be synchronously adjusted, to differentiate display brightness and effects of the simulated charcoal fires. For example, high temperature is used to simulate a more vigorous charcoal fire, and low temperature or a heat preservation stage is used to simulate a dim charcoal fire, so that the heating state can be vividly expressed and the user can be provided with psychological warmth in winter, thereby providing an emotional value.

The flame lamp board 32 includes a circuit board 321 on which two rows of flame lamp beads 322 are installed, where flame lamp beads 322 in a rear row are higher than flame lamp beads 322 in a front row. With such arrangement, the charcoal fire simulated by irradiation of the flame lamp bead 322 can be more stereoscopic and vivid. The charcoal fire simulation board 34 includes a transparent substrate 341, provided with transparent simulation blocks 342 at its front bottom, and the transparent simulation blocks 342 are in a shape of a stacked charcoal fire. The transparent substrate 341 can allow light to be incident on the transparent simulation blocks 342, and the transparent simulation blocks 342 present an image of the charcoal fire after irradiating light is reflected and refracted, to obtain a simulation effect. During working, the drive motor 331 can drive the drive shaft 332 to drive the rolling reflective sheets 333 to rotate, to periodically reflect light, so that the reflected light has a characteristic of movement and the simulated flame can have a dancing effect.

Finally, it should be noted that, obviously, the above embodiments are only examples for clearly describing the utility patent, and are not limitations on the embodiments. For persons of ordinary skills in the art, other changes or modifications in different forms may also be made on the basis of the above descriptions. It is unnecessary and impossible to exhaust all embodiments. Obvious changes or modifications derived therefrom shall still fall within the protection scope of the utility patent.

What is claimed is:

1. A towel heating bucket with a flame effect, comprising:
a bucket housing (1) in which an inner heating bucket (2) is fixedly disposed, c a top frame (4) is fixedly disposed at a top end of the inner heating bucket (2) and rotatably connected to a flip cover (5);
a flame simulation mechanism (3), installed on a front surface of the inner heating bucket (2); and
a regulator (6), instaled at an upper part of the front surface of the inner heating bucket (2);
wherein the flame simulation mechanism (3) comprises a light shielding box (31) in which a reflective mechanism (33) is disposed, a flame lamp board (32) is installed on a bottom side of the light shielding box (31), a charcoal fire simulation board (34) is installed on a front side of the light shielding box (31), and a transparent cover plate (35) is disposed on a front cover of the charcoal fire simulation board (34).

2. The towel heating bucket with a flame effect according to claim 1, wherein the flame lamp board (32) comprises a circuit board (321) on which two rows of flame lamp beads (322) are installed, wherein flame lamp beads (322) in a rear row are higher than flame lamp beads (322) in a front row.

3. The towel heating bucket with a flame effect according to claim 1, wherein the charcoal fire simulation board (34) comprises a transparent substrate (341), provided with transparent simulation blocks (342) at its front bottom, and the transparent simulation blocks (342) are in a shape of a stacked charcoal fire.

4. The towel heating bucket with a flame effect according to claim 1, wherein the reflective mechanism (33) comprises a drive motor (331) that is installed on a side surface of the light shielding box (31) and whose output shaft is fixedly connected to a drive shaft (332), and multiple rolling reflective sheets (333) that are spirally distributed are fixedly connected to the drive shaft (332).

5. The towel heating bucket with a flame effect according to claim 1, wherein the inner heating bucket (2) comprises an outer bucket layer (21) and an inner bucket layer (22), and a heating wire (23) is disposed therebetween and wound around the inner bucket layer (22) into a corrugated shape.

6. The towel heating bucket with a flame effect according to claim 1, wherein a power cord (8) is disposed at a bottom of the bucket housing (1), a storage plate (7) is fixedly disposed at a center of the bottom of the bucket housing (1), and a wire accommodation groove (71) configured to accommodate the power cord (8) is disposed in the storage plate (7).

7. The towel heating bucket with a flame effect according to claim 6, wherein the storage plate (7) is provided with a plug fixing groove (72) and a fixing clamping groove (73), both of which communicate with the wire accommodation groove (71), wherein the plug fixing groove (72) is located in the wire accommodation groove (71) and configured to fix a plug part of the power cord (8), and the fixing clamping groove (73) is on an outer side of the wire accommodation groove (71).

8. The towel heating bucket with a flame effect according to claim 1, wherein the regulator (6) is electrically connected to the inner heating bucket (2) and the flame simulation mechanism (3) to regulate working states thereof.
